(19) United States
(12) Patent Application Publication
(10) Pub. No.: US 2021/0291162 A1
(43) Pub. Date: Sep. 23, 2021

(54) Storage Vial

(71) Applicant: Global Life Sciences Solutions USA LLC, Marl borough, MA (US)

(72) Inventors: HannaLeena Saukkonen, Marlborough, MA (US); Ralph Stankowski, Westborough, MA (US); Elena Chernokalskaya, Westborough, MA (US); Corwin Card, Nibley, UT (US)

(21) Appl. No.: 17/046,172

(22) PCT Filed: Apr. 25, 2019
(86) PCT No.: PCT/US2019/029171

§ 371 Date: Oct. 8, 2020

Related U.S. Application Data
(60) Provisional application No. 62/662,265, filed on Apr. 25, 2018.

(51) Int. Cl. B01L 3/00

(52) U.S. Cl. CPC B01L 3/508; B01L 3/563; B01L 2200/0689; B01L 2400/0487; B01L 2300/0832; B01L 2300/1894; B01L 2300/049

(57) ABSTRACT

A storage vial (100, 200) may include a vial body (110, 210) having a first end (111, 211) and a second end (112, 212) and defining an internal volume (113, 213) configured to contain a biological material (B) therein, a first valve (120, 220) positioned at the first end of the vial body, a second valve (130, 230) positioned at the second end of the vial body, a first conduit connector (160, 260) positioned at the first end of the vial body, and a second conduit connector (170, 270) positioned at the second end of the vial body. The resulting construction may allow for closed system direct transfer of biological material from the storage vial to another vessel using aseptic techniques.

### CROSS-REFERENCE TO RELATED APPLICATIONS

This application claims the benefit of U.S. Provisional Application No. 62/662,265, filed Apr. 25, 2018, the entire contents of which are incorporated by reference herein.

### TECHNICAL FIELD

The present disclosure relates generally to storage vials suitable for aseptic cryogenic storage of biological material, such as cells, and more particularly to storage vials that allow for direct transfer of biological material from the storage vial to another vessel using aseptic techniques. The disclosure also relates to aseptic assemblies for transferring biological material from a storage vial to another vessel.

### BACKGROUND

Aseptic vials are commonly used for storage of biological material, for example in volumes of about 2 mL. Typically, such vials include a vial body defining a storage volume and a screw threaded cap or septum, which provide an opening to allow a pipette or needle to be used for drawing fluids out of the storage volume for transfer to another vessel. This action risks contamination of the biological material because the biological material has to be exposed to the internal surfaces of the pipette or needle and to the external environment. This exposure greatly increases the risk of contamination of the cell culture fluid.

A need therefore remains for improved storage vials and aseptic assemblies for use with biological material, which address one or more of the above-described limitations of existing technology and are able to allow for direct transfer of biological material from the storage vial to another vessel using aseptic techniques.

### SUMMARY

The present disclosure provides improved storage vials and aseptic assemblies for use with biological material. The storage vials described herein may include a vial body, a conduit connector positioned at each end of the vial body, and a valve or seal positioned at each end of the vial body. The storage vials may allow for connections of conduits at one or both ends of the storage vial, and therefore reduce risk of contamination through open exposure to the outside environment for access by pipette or needle may be avoided during transfer of the biological material. The storage vials described herein provide a closed-system for collection, storage and dispensing of biological materials with improved aseptic/sterile management. Fluid pressure or vacuum (i.e., below 1 atm pressure) in one of the connected conduits or both of the connected conduits may allow the opening of the valve or seal for aseptically transferring biological materials from the storage vial into one of the conduits and subsequently into a vessel of choice via the conduit. Alternatively, other mechanical valve types operated by manual, gravity, pump-assisted, or automated opening of a valve barrier can be used. In this manner, the storage vials may allow for efficient transfer of nearly all of the biological material therefrom, eliminate the need for pipetting the biological material in a controlled environment, and lower the risk of contamination.

According to one aspect, a storage vial is provided. In one embodiment, the storage vial may include a vial body having a first end and a second end and defining an internal volume configured to contain a biological material therein, a first valve positioned at the first end of the vial body, a second valve positioned at the second end of the vial body, a first conduit connector positioned at the first end of the vial body, and a second conduit connector positioned at the second end of the vial body.

In certain embodiments, the first valve and the second valve are pressure openable valves having a normally closed configuration but movable to an open configuration when fluid pressure is applied thereto. In certain embodiments, the first valve and the second valve each may include a flexible plug including a seal having one or more slits. In certain embodiments, the first valve may be positioned at least partially within the internal volume of the storage vial. In certain embodiments, the second valve may be positioned adjacent the internal volume of the storage vial. In certain embodiments, the storage vial also may include a first end cap positioned at the first end of the vial body, and a second end cap positioned at the second end of the vial body. In certain embodiments, the first valve may be attached to the first end cap, and the second valve may be attached to the second end cap. In certain embodiments, the first end cap may be removably attached to the vial body. In certain embodiments, the second end cap may be fixedly attached to the vial body. In certain embodiments, the first conduit connector may be attached to or a part of the first end cap, and the second conduit connector may be attached to or a part of the second end cap.

According to another aspect, an aseptic assembly for transferring a biological material is provided. In one embodiment, the aseptic assembly may include a storage vial including a vial body having a first end and a second end and defining an internal volume configured to contain the biological material therein, a first valve positioned at the first end of the vial body, a second valve positioned at the second end of the vial body, a first conduit connector positioned at the first end of the vial body, and a second conduit connector positioned at the second end of the vial body. The assembly also may include a first conduit removably attached to the first conduit connector, and a second conduit removably attached to the second conduit connector.

In certain embodiments, the aseptic assembly also may include a syringe attached to the first conduit and configured to induce a pressure differential between the first conduit and the second conduit to effect a flow of the biological material from the storage vial into the second conduit. In certain embodiments, the aseptic assembly also may include a pump engaging the first conduit and configured to induce a pressure differential between the first conduit and the second conduit to effect a flow of the biological material from the storage vial into the second conduit. In certain embodiments, the aseptic assembly also may include a receiving vessel attached to the second conduit and configured to receive the biological material therefrom. In certain embodiments, the first valve and the second valve may be pressure openable valves having a normally closed configuration but self-opening or movable to an open configuration when fluid pressure is applied thereto. In certain embodiments, the valves may operate mechanically, such as via a turnable stopcock, and/or be driven by gravity, head pressure or a pump.

According to another aspect, a storage vial is provided. In one embodiment, the storage vial may include a vial body having a first end and a second end and defining an internal volume configured to contain a biological material therein, a first conduit connector positioned at the first end of the vial body, and a second conduit connector positioned at the second end of the vial body.

In certain embodiments, the storage vial also may include an end cap removably attached to the first end of the vial body, wherein the first conduit connector is attached to the end cap. In certain embodiments, an end portion of the second conduit connector may be positioned within the internal volume of the vial body such that the second conduit connector and the vial body define a cell retention volume therebetween. In certain embodiments, the storage vial also may include a tube attached to the first conduit connector and extending into the internal volume of the vial body. In certain embodiments, a longitudinal axis of at least one of the first conduit connector and the second conduit connector may extend transverse to a longitudinal axis of the vial body.

These and other aspects and embodiments of the present disclosure will be apparent or will become apparent to one of ordinary skill in the art upon review of the following detailed description when taken in conjunction with the several drawings and the appended claims.

The present disclosure extends to any combination of components or features disclosed herein, whether or not such a combination is mentioned explicitly herein. Further, where two or more components or features are mentioned in combination, it is intended that such components or features may be claimed separately without extending the scope of the disclosure.

### BRIEF DESCRIPTION OF THE DRAWINGS

Embodiments of the present disclosure can be put into effect in numerous ways. In describing illustrative embodiments of the disclosure, reference is made to the accompanying drawings, which are not necessarily drawn to scale, and wherein:

FIG. 1 is a side view of a storage vial in accordance with one or more embodiments of the disclosure, showing a vial body, a pair of valves, and a pair of end caps;

FIG. 2A is a perspective view of a storage vial in accordance with one or more embodiments of the disclosure, showing a vial body, a pair of valves, and a pair of end caps;

FIG. 2B is an exploded perspective view of the storage vial of FIG. 2A;

FIG. 2C is a cross-sectional perspective view of the storage vial of FIG. 2A;

FIG. 3 is a schematic diagram of an aseptic assembly for transferring biological material in accordance with one or more embodiments of the disclosure, showing a storage vial, a pair of conduits, a syringe, and a receiving vessel;

FIG. 4 is a schematic diagram of an aseptic assembly for transferring biological material in accordance with one or more embodiments of the disclosure, showing a storage vial, a pair of conduits, a peristaltic pump, and a receiving vessel;

FIG. 5A is a cross-sectional side view of a storage vial in accordance with one or more embodiments of the disclosure, showing a vial body, a pair of conduit connectors, an end cap, and a mixture including biological material contained within the storage vial;

FIG. 5B is a cross-sectional side view of the storage vial of FIG. 5A after centrifuging of the storage vial, showing pelletized cells separated from a remainder of the mixture;

FIG. 6 is a cross-sectional side view of a storage vial in accordance with one or more embodiments of the disclosure, showing a vial body, a pair of conduit connectors, an end cap, and pelletized cells separated from a remainder a mixture including biological material contained within the storage vial;

FIG. 7A is a cross-sectional side view of a storage vial in accordance with one or more embodiments of the disclosure, showing a vial body, a pair of conduit connectors, an end cap, a tube, and pelletized cells separated from a remainder a mixture including biological material contained within the storage vial after centrifuging of the storage vial;

FIG. 7B is a cross-sectional side view of a storage vial in accordance with one or more embodiments of the disclosure, showing a vial body, a pair of conduit connectors, an end cap, a tube, and pelletized cells separated from a remainder a mixture including biological material contained within the storage vial after centrifuging of the storage vial;

FIG. 8A is a cross-sectional side view of a storage vial in accordance with one or more embodiments of the disclosure, showing a vial body and a pair of conduit connectors; and

FIG. 8B is a cross-sectional side view of a storage vial in accordance with one or more embodiments of the disclosure, showing a vial body and a pair of conduit connectors.

### DETAILED DESCRIPTION

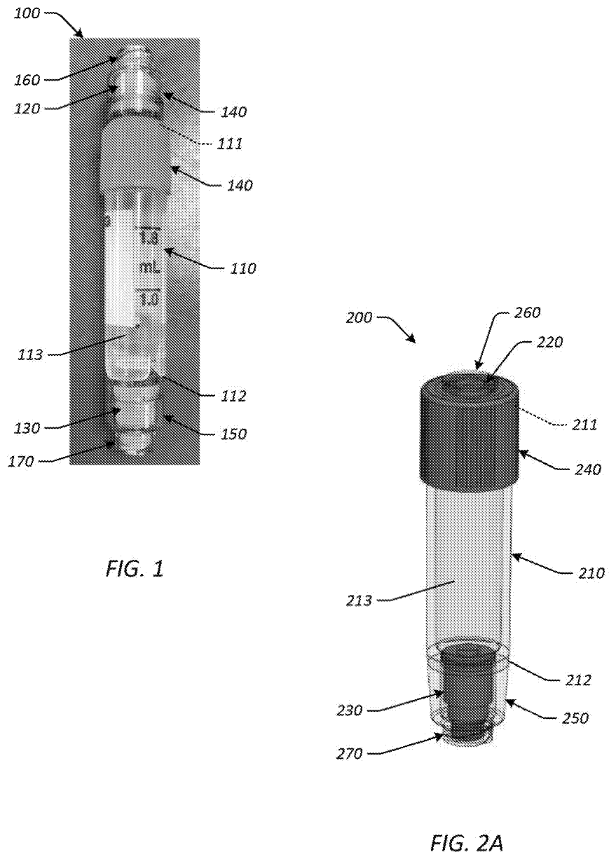

FIG. 1 illustrates a storage vial 100 (which also may be referred to herein as an “aseptic storage vial” or a “vial”) and components and features thereof according to one or more embodiments of the disclosure. The storage vial 100 essentially provides a closed-system that may be used for storing and handling a fluid mixture including biological material to avoid contamination. As described below, the storage vial 100 may allow for direct transfer of the biological material from the storage vial 100 to another vessel using aseptic techniques. As shown, the storage vial 100 may include a vial body 110, a first valve 120, a second valve 130, a first end cap 140, a second end cap 150, a first conduit connector 160, and a second conduit connector 170.

As shown, the vial body 110 may have a first end 111 (indicated by a dashed reference line in FIG. 1 because the first end is positioned within the first end cap 140) and a second end 112 positioned opposite one another along a longitudinal axis of the vial body 110. The vial body 110 may define an internal storage volume 113 therein, extending from a first opening at the first end 111 to a second opening at the second end 112. The storage volume 113 may be configured for containing a fluid mixture therein. In some embodiments, as shown, the vial body 110 may have a cylindrical, tubular shape, although other shapes of the vial body 110 may be used.

The first valve 120 may be positioned at the first end 111 of the vial body 110, and the second valve 130 may be positioned at the second end 112 of the valve body 110. In some embodiments, the first valve 120 and/or the second valve 130 may be positioned adjacent the respective ends 111, 112 of the valve body 110. In some embodiments, the first valve 120 and/or the second valve 130 may be positioned at least partially within the valve body 110. In other words, one or both of the first valve 120 and the second valve 130 may be positioned at least partially within the storage volume 113. In some embodiments, the first valve 120 and the second valve 130 may be pressure openable valves having a normally closed configuration but self-movable to an open configuration when pressure is applied to the valve. Other types of valves may be used for the first valve 120 and the second valve 130. In some embodiments, the first valve 120 and the second valve 130 may be identical to one another. In some embodiments, the first valve 120 and the second valve 130 may have different configurations.

As shown, the first end cap 140 may be attached to the first end 111 of the vial body 110, and the second end cap 150 may be attached to the second end 112 of the vial body 110. The first valve 120 may be attached to and/or contained by the first end cap 140, and the second valve 130 may be attached to and/or contained by the second end cap 150. The first end cap 140 and the second end cap 150 each may be formed as hollow members with open ends. In this manner, exposed external surfaces of the first valve 120 may be accessible through one of the open ends of the first end cap 140, and exposed external surfaces of the second valve 130 may be accessible through one of the open ends of the second end cap 150. In some embodiments, the first end cap 140 may be removably attached to the vial body 110, for example by mating threads or other mating features of the first end cap 140 and the vial body 110. In this manner, the first end cap 140 and the first valve 120 may be removed from the vial body 110 for loading the fluid mixture into the storage vial 100 in a conventional manner and then attached to the vial body 110 for storage or handling. In some embodiments, the first end cap 140 may be fixedly attached to the vial body 110. In this manner, the fluid mixture may be loaded into the storage vial 100 through the first end cap 140 and the first valve 120. In some embodiments, the second end cap 150 may be removably attached to the vial body 110. In this manner, the second end cap 150 and the second valve 130 may be removed from the vial body 110. In some embodiments, the second end cap 150 may be fixedly attached to the vial body 110. In some embodiments, the first end cap 140 may include multiple portions that are attached to one another. For example, as shown in FIG. 1, the first end cap 140 may include a first portion that contains the first valve 120 and a second portion that removably attaches to the first end 111 of the vial body 110.

As shown, the first conduit connector 160 may be positioned at the first end of the storage vial 100, and the second conduit connector 170 may be positioned at the second end of the storage vial 100. The first conduit connector 160 may be configured for connecting the storage vial 100 to a first conduit, and the second conduit connector 170 may be configured for connecting the storage vial 100 to a second conduit, for example during transfer of biological material from the storage vial 100 to another vessel, as described below. The first conduit connector 160 and the second conduit connector 170 may be sterile or aseptic connectors for connecting the storage vial 100 to the respective conduits. In some embodiments, the first conduit connector 160 and the second conduit connector 170 may be luer-lock connectors, although other types of connectors may be used. In some embodiments, the first conduit connector 160 may be integrally formed with or a part of the first end cap 140, and the second conduit connector 170 may be integrally formed with or a part of the second end cap 150. In some embodiments, the first conduit connector 160 may be separately formed and attached to the first end cap 140, and the second conduit connector 170 may be separately formed and attached to the second end cap 150.

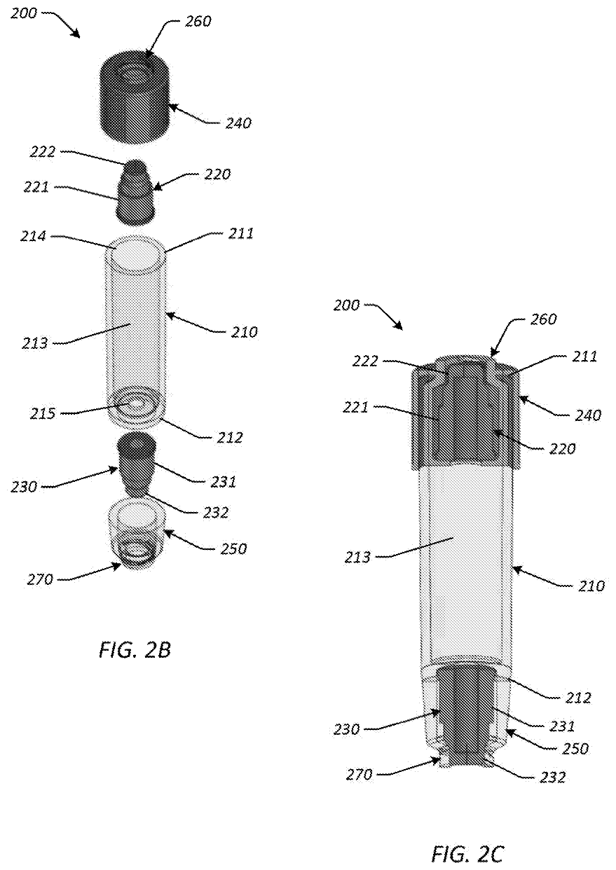

FIGS. 2A-2C illustrate a storage vial 200 (which also may be referred to herein as an “aseptic storage vial” or a “vial”) and components and features thereof according to one or more embodiments of the disclosure. The storage vial 200 may be used for storing and handling a fluid mixture including biological material. As described below, the storage vial 200 may allow for direct transfer of the biological material from the storage vial 200 to another vessel using aseptic techniques. As shown, the storage vial 200 may include a vial body 210, a first valve 220, a second valve 230, a first end cap 240, a second end cap 250, a first conduit connector 260, and a second conduit connector 270.

As shown, the vial body 210 may have a first end 211 and a second end 212 positioned opposite one another along a longitudinal axis of the vial body 210. The vial body 210 may define an internal storage volume 213 therein, extending from a first opening 214 at the first end 211 to a second opening 215 at the second end 212. The storage volume 213 may be configured for containing a fluid mixture therein. In some embodiments, as shown, the vial body 210 may have a cylindrical, tubular shape, although other shapes of the vial body 210 may be used.

The first valve 220 may be positioned at the first end 211 of the vial body 210, and the second valve 230 may be positioned at the second end 212 of the valve body 210. In some embodiments, the first valve 220 and/or the second valve 230 may be positioned adjacent the respective ends 211, 212 of the valve body 210. In some embodiments, the first valve 220 and/or the second valve 230 may be positioned at least partially within the valve body 210. In other words, one or both of the first valve 220 and the second valve 230 may be positioned at least partially within the storage volume 213. In some embodiments, as shown, the first valve 220 may be positioned at least partially within the valve body 210, and the second valve 230 may be positioned adjacent the second end 212 of the valve body 210. In some embodiments, the first valve 220 and the second valve 230 may be pressure openable valves having a normally closed configuration but movable to an open configuration when pressure is applied to the valve. In some embodiments, as shown, the first valve 220 may include a flexible plug 221 including a seal 222 having one or more slits or other apertures openable under fluid pressure but normally aseptically closed. In some embodiments, as shown, the second valve 230 similarly may include a flexible plug 231 including a seal 232 having one or more slits or other apertures openable under fluid pressure but normally aseptically closed. In some embodiments, the seals 222, 232 of the first valve 220 and the second valve 230 may be formed from a flexible silicone material. Whilst the valves 220, 230 are shown as formed from slitted seals 222, 232, it will be apparent that other types of pressure openable valves may be employed, for example biased flaps, and sprung ball seated valves may be used for the valves 220, 230 in some embodiments. Further, in some embodiments, a rupturable septum or the like may be used for the valves 220, 230 to achieve the same effect. In some embodiments, as shown, the first valve 220 and the second valve 230 may be identical to one another. In some embodiments, the first valve 220 and the second valve 230 may have different configurations.

As shown, the first end cap 240 may be attached to the first end 211 of the vial body 210, and the second end cap 250 may be attached to the second end 212 of the vial body 210. The first valve 220 may be attached to and/or contained by the first end cap 240, and the second valve 230 may be attached to and/or contained by the second end cap 250. The first end cap 240 and the second end cap 250 each may be formed as hollow members with open ends. In this manner, exposed external surfaces of the first valve 220 may be accessible through one of the open ends of the first end cap 240, and exposed external surfaces of the second valve 230 may be accessible through one of the open ends of the second end cap 250. In some embodiments, as shown, the first end cap 240 may be removably attached to the vial body 210, for example by mating threads or other mating features of the first end cap 240 and the vial body 210. In this manner, the first end cap 240 and the first valve 220 may be removed from the vial body 210 for loading the fluid mixture into the storage vial 200 in a conventional manner and then attached to the vial body 210 for storage or handling. In some embodiments, the first end cap 240 may be fixedly attached to the vial body 210. In this manner, the fluid mixture may be loaded into the storage vial 200 through the first end cap 240 and the first valve 220. In some embodiments, the second end cap 250 may be removably attached to the vial body 210. In this manner, the second end cap 250 and the second valve 230 may be removed from the vial body 210. In some embodiments, as shown, the second end cap 250 may be fixedly attached to the vial body 210.

As shown, the first conduit connector 260 may be positioned at the first end of the storage vial 200, and the second conduit connector 270 may be positioned at the second end of the storage vial 200. The first conduit connector 260 may be configured for connecting the storage vial 200 to a first conduit, and the second conduit connector 270 may be configured for connecting the storage vial 200 to a second conduit, for example during transfer of biological material from the storage vial 200 to another vessel, as described below. The first conduit connector 260 and the second conduit connector 270 may be sterile or aseptic connectors for connecting the storage vial 200 to the respective conduits. In some embodiments, the first conduit connector 260 and the second conduit connector 270 may be luer-lock connectors, although other types of connectors may be used. In some embodiments, as shown, the first conduit connector 260 may be integrally formed with or a part of the first end cap 240, and the second conduit connector 270 may be integrally formed with or a part of the second end cap 250. In some embodiments, the first conduit connector 260 may be separately formed and attached to the first end cap 240, and the second conduit connector 270 may be separately formed and attached to the second end cap 250.

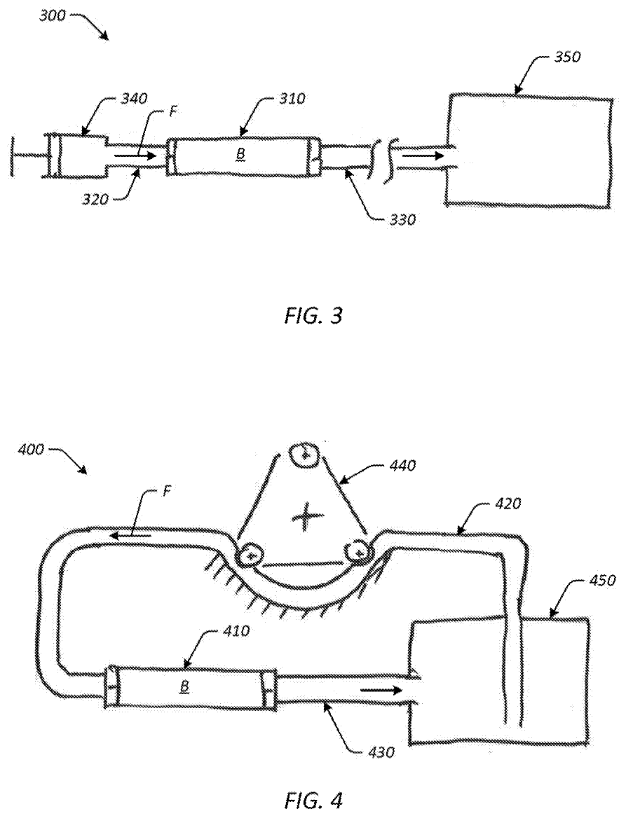

FIG. 3 illustrates an aseptic assembly 300 (which also may be referred to herein as an “aseptic transfer assembly” or an “assembly”) for transferring biological material in accordance with one or more embodiments of the disclosure. As shown, the aseptic assembly 300 may include a storage vial 310, a first conduit 320, a second conduit 330, a syringe 340, and a receiving vessel 350. The storage vial 310 may be one of the storage vials 100, 200 described above or one of the storage vials described herein below. The first conduit 320 may be attached to the first conduit connector 160, 260, and the second conduit 330 may be attached to the second conduit connector 170, 270, as shown. In some embodiments, the first conduit 320 and the second conduit 330 may be formed of flexible tubing, although other types of conduits may be used. The syringe 340 may be connected to the other end of the first conduit 320 opposite the storage vial 310, and the receiving vessel 350 may be connected to the other end of the second conduit 330 opposite the storage vial 310. During operation of the aseptic assembly 300, the syringe 340 may be used to force fluid in the direction of a flow F along the first conduit 320 to urge biological material B out of the storage vial 310, through the second conduit 330, and into the receiving vessel 350. It will be appreciated that during use of the aseptic assembly 300, once the conduits 320, 330 are connected to the storage vial 310, there is no exposure to the environment and therefore the risk of contamination is lower than using a pipette or needle. Further, the externally exposed surfaces of the valves 120, 130, 220 230 of the storage vial 310 may be swabbable, for example using a cleaning swab or the like, and thus may be cleaned prior to connection of the conduits 320, 330 to reduce the risk of contamination.

FIG. 4 illustrates an aseptic assembly 400 (which also may be referred to herein as an “aseptic transfer assembly” or an “assembly”) for transferring biological material in accordance with one or more embodiments of the disclosure. As shown, the aseptic assembly 400 may include a storage vial 410, a first conduit 420, a second conduit 430, a peristaltic pump 440, and a receiving vessel 450. The storage vial 410 may be one of the storage vials 100, 200 described above or one of the storage vials described herein below. The first conduit 420 may be attached to the first conduit connector 160, 260, and the second conduit 430 may be attached to the second conduit connector 170, 270, as shown. In some embodiments, the first conduit 420 and the second conduit 430 may be formed of flexible tubing, although other types of conduits may be used. The peristaltic pump 440 may be engaged with the first conduit 420, and the receiving vessel 450 may be connected to the other end of the second conduit 430 opposite the storage vial 410. During operation of the aseptic assembly 400, the peristaltic pump 440 may be used to force fluid in the direction of a flow F along the first conduit 420 to urge biological material B out of the storage vial 410, through the second conduit 430, and into the receiving vessel 450. In some embodiments, as shown, the flow F may result from recirculating operation of the peristaltic pump 440. It will be appreciated that during use of the aseptic assembly 400, once the conduits 420, 430 are connected to the storage vial 410, there is no exposure to the environment and therefore the risk of contamination is lower than using a pipette or needle. Further, the externally exposed surfaces of the valves 120, 130, 220 230 of the storage vial 410 may be swabbable, for example using a cleaning swab or the like, and thus may be cleaned prior to connection of the conduits 420, 430 to reduce the risk of contamination.

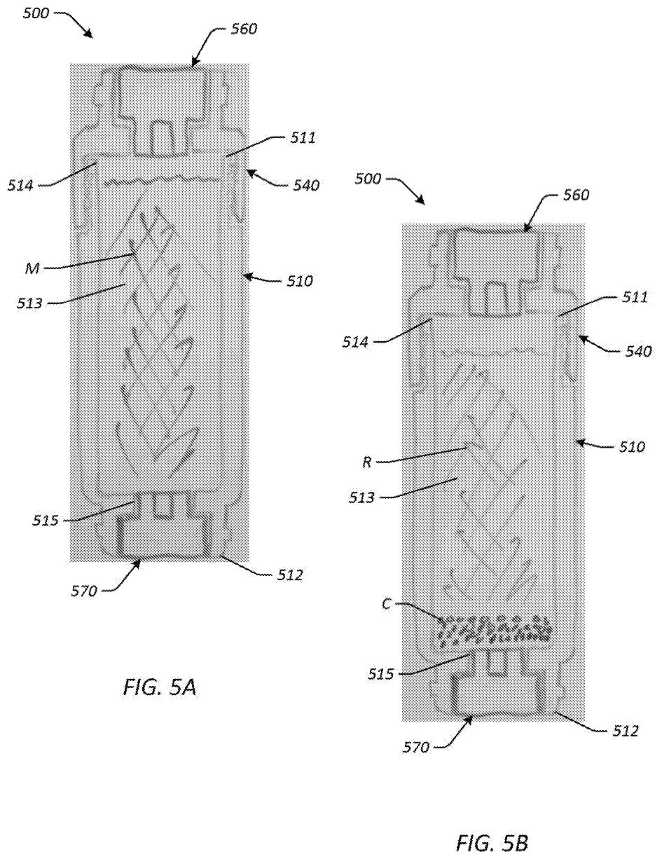

FIGS. 5A and 5B illustrate a storage vial 500 (which also may be referred to herein as an “aseptic storage vial” or a “vial”) and components and features thereof according to one or more embodiments of the disclosure. The storage vial 500 may be used for storing and handling a fluid mixture M including biological material. The storage vial 500 may allow for direct transfer of the biological material from the storage vial 500 to another vessel using aseptic techniques, for example in a manner similar to that described above with respect to FIGS. 3 and 4. As shown, the storage vial 500 may include a vial body 510, an end cap 540, a first conduit connector 560, and a second conduit connector 570.

As shown, the vial body 510 may have a first end 511 and a second end 512 positioned opposite one another along a longitudinal axis of the vial body 510. The vial body 510 may define an internal storage volume 513 therein, extending from a first opening 514 at the first end 511 to a second opening 515 at the second end 512. The storage volume 513 may be configured for containing the fluid mixture M therein. In some embodiments, as shown, the vial body 510 may have a cylindrical, tubular shape, although other shapes of the vial body 510 may be used.

As shown, the end cap 540 may be attached to the first end 511 of the vial body 510. In some embodiments, the end cap 540 may be removably attached to the vial body 510, for example by mating threads or other mating features of the end cap 540 and the vial body 510. In this manner, the end cap 540 may be removed from the vial body 510 for loading the fluid mixture M into the storage vial 500 in a conventional manner and then attached to the vial body 510 for storage or handling. In some embodiments, the end cap 540 may be fixedly attached to the vial body 510. In this manner, the fluid mixture M may be loaded into the storage vial 500 through the end cap 540.

As shown, the first conduit connector 560 may be positioned at the first end of the storage vial 500, and the second conduit connector 570 may be positioned at the second end of the storage vial 500. The first conduit connector 560 may be configured for connecting the storage vial 500 to a first conduit, and the second conduit connector 570 may be configured for connecting the storage vial 500 to a second conduit, for example during transfer of biological material from the storage vial 500 to another vessel, as described above. The first conduit connector 560 and the second conduit connector 570 may be sterile or aseptic connectors for connecting the storage vial 500 to the respective conduits. In some embodiments, the first conduit connector 560 and the second conduit connector 570 may be luer-lock connectors, although other types of connectors may be used. In some embodiments, the first conduit connector 560 may be integrally formed with or a part of the end cap 540. In some embodiments, the first conduit connector 560 may be separately formed and attached to the end cap 540. In some embodiments, the first conduit connector 560 may include or may be attached to a first valve similar to the first valves 120, 220 described above. In some embodiments, the second conduit connector 570 may include or may be attached to a second valve similar to the second valves 130, 230 described above.

FIG. 5A shows the fluid mixture M contained within the storage vial 500 prior to centrifuging. The fluid mixture M may include biological material, one or more preservatives or cryoprotectants, such as dimethyl sulfoxide (DMSO), and/or one or more additional components. FIG. 5B shows the storage vial 500 after centrifuging, where pelletized cells C have separated from a remainder R of the fluid mixture M. As a result, the remainder R of the fluid mixture may be removed from the storage vial 500 separately from the pelletized cells C of the fluid mixture M.

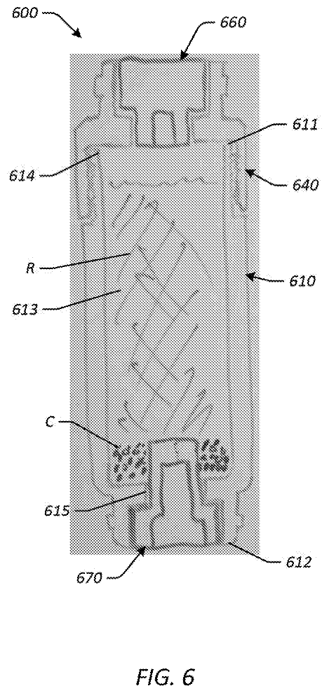

FIG. 6 illustrates a storage vial 600 (which also may be referred to herein as an “aseptic storage vial” or a “vial”) and components and features thereof according to one or more embodiments of the disclosure. The storage vial 600 may be used for storing and handling a fluid mixture including biological material. The storage vial 600 may allow for direct transfer of the biological material from the storage vial 600 to another vessel using aseptic techniques, for example in a manner similar to that described above with respect to FIGS. 3 and 4. As shown, the storage vial 600 may include a vial body 610, an end cap 640, a first conduit connector 660, and a second conduit connector 670.

As shown, the vial body 610 may have a first end 611 and a second end 612 positioned opposite one another along a longitudinal axis of the vial body 610. The vial body 610 may define an internal storage volume 613 therein, extending from a first opening 614 at the first end 611 to a second opening 615 at the second end 612. The storage volume 613 may be configured for containing the fluid mixture therein. In some embodiments, as shown, the vial body 610 may have a cylindrical, tubular shape, although other shapes of the vial body 610 may be used.

As shown, the end cap 640 may be attached to the first end 611 of the vial body 610. In some embodiments, the end cap 640 may be removably attached to the vial body 610, for example by mating threads or other mating features of the end cap 640 and the vial body 610. In this manner, the end cap 640 may be removed from the vial body 610 for loading the fluid mixture into the storage vial 600 in a conventional manner and then attached to the vial body 610 for storage or handling. In some embodiments, the end cap 640 may be fixedly attached to the vial body 610. In this manner, the fluid mixture may be loaded into the storage vial 600 through the end cap 640.

As shown, the first conduit connector 660 may be positioned at the first end of the storage vial 600, and the second conduit connector 670 may be positioned at the second end of the storage vial 600. The first conduit connector 660 may be configured for connecting the storage vial 600 to a first conduit, and the second conduit connector 670 may be configured for connecting the storage vial 600 to a second conduit, for example during transfer of biological material from the storage vial 600 to another vessel, as described above. The first conduit connector 660 and the second conduit connector 670 may be sterile or aseptic connectors for connecting the storage vial 600 to the respective conduits. In some embodiments, the first conduit connector 660 and the second conduit connector 670 may be luer-lock connectors, although other types of connectors may be used. In some embodiments, the first conduit connector 660 may be integrally formed with or a part of the end cap 640. In some embodiments, the first conduit connector 660 may be separately formed and attached to the end cap 640. In some embodiments, the first conduit connector 660 may include or may be attached to a first valve similar to the first valves 120, 220 described above. In some embodiments, the second conduit connector 670 may include or may be attached to a second valve similar to the second valves 130, 230 described above. In some embodiments, as shown, an end portion of the second conduit connector 670 may be positioned within the internal volume 613 of the vial body 610. In this manner, the end portion of the second conduit connector 670 and the vial body 610 may define a cell retention volume in which pelletized calls may collect after centrifuging of the storage vial 600.

FIG. 6 shows the storage vial 600 after loading a fluid mixture therein and centrifuging. The fluid mixture may include biological material, spent cell culture media, one or more cryopreservatives or cryoprotectants, such as DMSO, and/or one or more additional components. As shown, after centrifuging, pelletized cells C may be separated from a remainder R of the fluid mixture and collected in the cell retention volume. As a result, the pelletized cells C may be removed from the storage vial 600 separately from the remainder R of the fluid mixture.

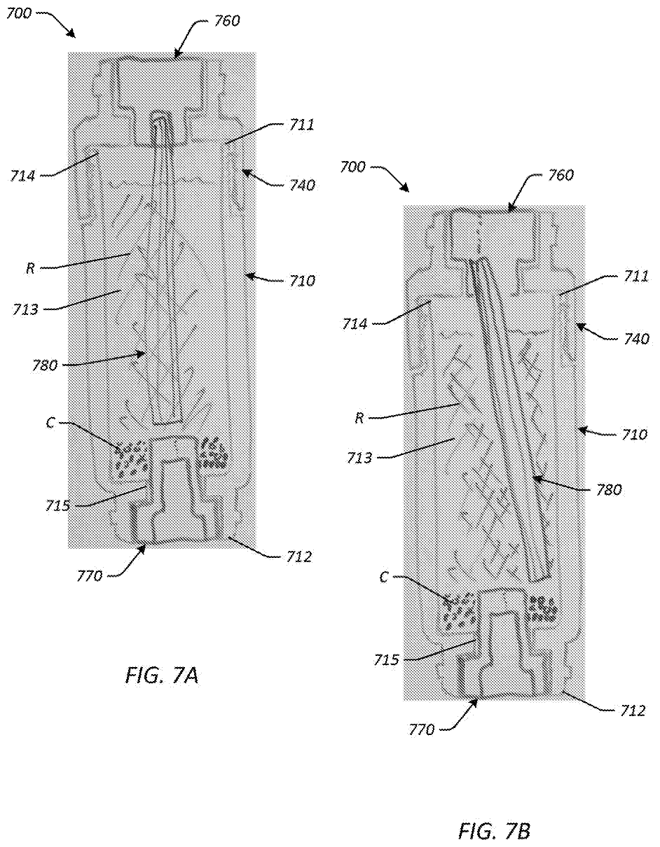

FIGS. 7A and 7B illustrate a storage vial 700 (which also may be referred to herein as an “aseptic storage vial” or a “vial”) and components and features thereof according to one or more embodiments of the disclosure. The storage vial 700 may be used for storing and handling a fluid mixture including biological material. The storage vial 700 may allow for direct transfer of the biological material from the storage vial 700 to another vessel using aseptic techniques, for example in a manner similar to that described above with respect to FIGS. 3 and 4. As shown, the storage vial 700 may include a vial body 710, an end cap 740, a first conduit connector 760, a second conduit connector 770, and a tube 780.

As shown, the vial body 710 may have a first end 711 and a second end 712 positioned opposite one another along a longitudinal axis of the vial body 710. The vial body 710 may define an internal storage volume 713 therein, extending from a first opening 714 at the first end 711 to a second opening 715 at the second end 712. The storage volume 713 may be configured for containing the fluid mixture therein. In some embodiments, as shown, the vial body 710 may have a cylindrical, tubular shape, although other shapes of the vial body 710 may be used.

As shown, the end cap 740 may be attached to the first end 711 of the vial body 710. In some embodiments, the end cap 740 may be removably attached to the vial body 710, for example by mating threads or other mating features of the end cap 740 and the vial body 710. In this manner, the end cap 740 may be removed from the vial body 710 for loading the fluid mixture into the storage vial 700 in a conventional manner and then attached to the vial body 710 for storage or handling. In some embodiments, the end cap 740 may be fixedly attached to the vial body 710. In this manner, the fluid mixture may be loaded into the storage vial 700 through the end cap 740.

As shown, the first conduit connector 760 may be positioned at the first end of the storage vial 700, and the second conduit connector 770 may be positioned at the second end of the storage vial 700. The first conduit connector 760 may be configured for connecting the storage vial 700 to a first conduit, and the second conduit connector 770 may be configured for connecting the storage vial 700 to a second conduit, for example during transfer of biological material from the storage vial 700 to another vessel, as described above. The first conduit connector 760 and the second conduit connector 770 may be sterile or aseptic connectors for connecting the storage vial 700 to the respective conduits. In some embodiments, the first conduit connector 760 and the second conduit connector 770 may be luer-lock connectors, although other types of connectors may be used. In some embodiments, the first conduit connector 760 may be integrally formed with or a part of the end cap 740. In some embodiments, the first conduit connector 760 may be separately formed and attached to the end cap 740. In some embodiments, the first conduit connector 760 may include or may be attached to a first valve similar to the first valves 120, 220 described above. In some embodiments, the second conduit connector 770 may include or may be attached to a second valve similar to the second valves 130, 230 described above. In some embodiments, as shown, an end portion of the second conduit connector 770 may be positioned within the internal volume 713 of the vial body 710. In this manner, the end portion of the second conduit connector 770 may define a cell retention volume in which pelletized calls may collect after centrifuging of the storage vial 700.

As shown, the tube 780 may be attached to the first conduit connector 760 and extend downwardly therefrom into the internal volume 713 of the vial body 710. In some embodiments, as shown in FIG. 7A, the longitudinal axis of the tube 780 may be coaxial with the longitudinal axis of the vial body 710. In some embodiments, the longitudinal axis of the tube 780 may be offset from and parallel to the longitudinal axis of the vial body 710. In some embodiments, as shown in FIG. 7B, the longitudinal axis of the tube 780 may angled relative to the longitudinal axis of the vial body 710.

FIGS. 7A and 7B show the storage vial 700 after loading a fluid mixture therein and centrifuging. The fluid mixture may include biological material, one or more preservatives or cryoprotectants, such as DMSO, and/or one or more additional components. As shown, after centrifuging, pelletized cells C may be separated from a remainder R of the fluid mixture and collected in the cell retention volume. As a result, the pelletized cells C may be removed from the storage vial 700 separately from the remainder R of the fluid mixture. For example, the tube 780 may be used to remove the remainder R of the fluid mixture, and then the pelletized cells C may be removed.

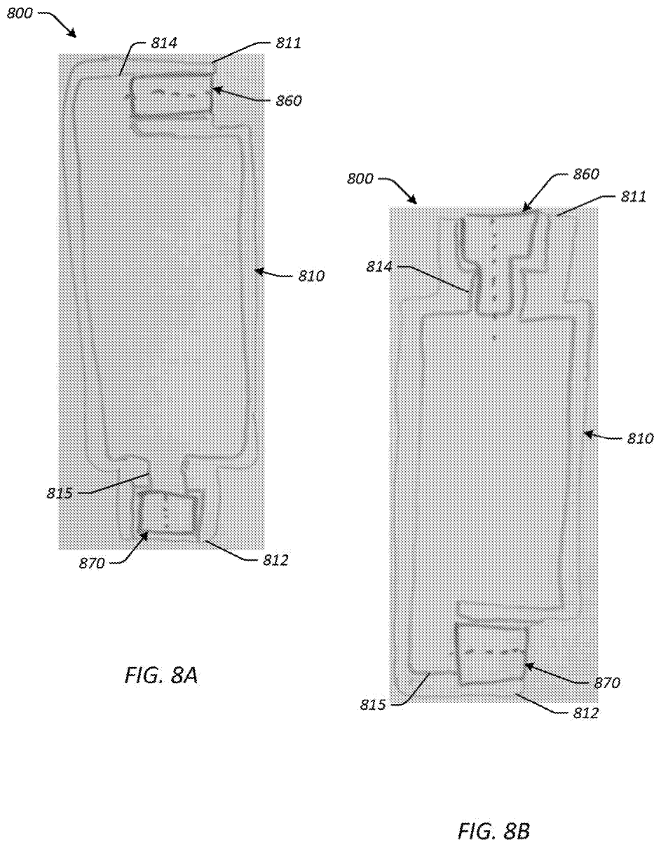

FIGS. 8A and 8B illustrate a storage vial 800 (which also may be referred to herein as an “aseptic storage vial” or a “vial”) and components and features thereof according to one or more embodiments of the disclosure. The storage vial 800 may be used for storing and handling a fluid mixture including biological material. The storage vial 800 may allow for direct transfer of the biological material from the storage vial 800 to another vessel using aseptic techniques, for example in a manner similar to that described above with respect to FIGS. 3 and 4. As shown, the storage vial 800 may include a vial body 810, a first conduit connector 860, and a second conduit connector 870.

As shown, the vial body 810 may have a first end 811 and a second end 812 positioned opposite one another along a longitudinal axis of the vial body 810. The vial body 810 may define an internal storage volume 813 therein, extending from a first opening 814 at the first end 811 to a second opening 815 at the second end 812. The storage volume 813 may be configured for containing the fluid mixture therein. In some embodiments, as shown, the vial body 810 may have a generally cylindrical, tubular shape, although other shapes of the vial body 810 may be used.

As shown, the first conduit connector 860 may be positioned at the first end of the storage vial 800, and the second conduit connector 870 may be positioned at the second end of the storage vial 800. The first conduit connector 860 may be configured for connecting the storage vial 800 to a first conduit, and the second conduit connector 870 may be configured for connecting the storage vial 800 to a second conduit, for example during transfer of biological material from the storage vial 800 to another vessel, as described above. The first conduit connector 860 and the second conduit connector 870 may be sterile or aseptic connectors for connecting the storage vial 800 to the respective conduits. In some embodiments, the first conduit connector 860 and the second conduit connector 870 may be luer-lock connectors, although other types of connectors may be used. In some embodiments, the first conduit connector 860 may include or may be attached to a first valve similar to the first valves 120, 220 described above. In some embodiments, the second conduit connector 870 may include or may be attached to a second valve similar to the second valves 130, 230 described above. In some embodiments, the longitudinal axis of one or both of the first conduit connector 860 and the second conduit connector 870 may be oriented transverse to the longitudinal axis of the vial body 810. In some embodiments, as shown in FIG. 8A, the longitudinal axis of the first conduit connector 860 may be oriented transverse to the longitudinal axis of the vial body 810, and the longitudinal axis of the second conduit connector 870 may be coaxial with the longitudinal axis of the vial body 810. In some embodiments, as shown in FIG. 8B, the longitudinal axis of the second conduit connector 870 may be oriented transverse to the longitudinal axis of the vial body 810, and the longitudinal axis of the first conduit connector 860 may be coaxial with the longitudinal axis of the vial body 810. In some embodiments, the longitudinal axis of the first conduit connector 860 and the longitudinal axis of the second conduit connector 870 both may be oriented transverse to the longitudinal axis of the vial body 810.

Many modifications of the embodiments of the present disclosure will come to mind to one skilled in the art to which the disclosure pertains upon having the benefit of the teachings presented herein through the foregoing descriptions and the associated drawings. Therefore, it is to be understood that the present invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A storage vial comprising a vial body having a first end and a second end and defining an internal volume configured to contain a biological material therein, a first valve positioned at the first end of the vial body, a second valve positioned at the second end of the vial body, a first conduit connector positioned at the first end of the vial body, and a second conduit connector positioned at the second end of the vial body.

2. A storage vial as claimed in claim 1, wherein the first valve and the second valve are pressure openable valves having a normally closed configuration but movable to an open configuration when fluid pressure is applied thereto.

3. A storage vial as claimed in claim 2, wherein the first valve and the second valve each comprise a flexible plug including a seal having one or more slits.

4. A storage vial as claimed in claim 1, wherein the first valve is positioned at least partially within the internal volume of the storage vial.

5. A storage vial as claimed in claim 4, wherein the second valve is positioned adjacent the internal volume of the storage vial.

6. A storage vial as claimed in claim 1, further comprising a first end cap positioned at the first end of the vial body, and a second end cap positioned at the second end of the vial body.

7. A storage vial as claimed in claim 6, wherein the first valve is attached to the first end cap, and wherein the second valve is attached to the second end cap.

8. A storage vial as claimed in claim 7, wherein the first end cap is removably attached to the vial body.

9. A storage vial as claimed in claim 8, wherein the second end cap is fixedly attached to the vial body.

10. A storage vial as claimed in claim 6, wherein the first conduit connector is attached to or a part of the first end cap, and wherein the second conduit connector is attached to or a part of the second end cap.

11. An aseptic assembly for transferring a biological material, the assembly comprising a storage vial comprising a vial body having a first end and a second end and defining an internal volume configured to contain the biological material therein, a first valve positioned at the first end of the vial body, a second valve positioned at the second end of the vial body, a first conduit connector positioned at the first end of the vial body, and a second conduit connector positioned at the second end of the vial body, the assembly further comprising a first conduit removably attached to the first conduit connector, and a second conduit removably attached to the second conduit connector.

12. An aseptic assembly as claimed in claim 11, further comprising a syringe attached to the first conduit and configured to induce a pressure differential between the first conduit and the second conduit to effect a flow of the biological material from the storage vial into the second conduit.

13. An aseptic assembly as claimed in claim 11, further comprising a pump engaging the first conduit and configured to induce a pressure differential between the first conduit and the second conduit to effect a flow of the biological material from the storage vial into the second conduit.

14. An aseptic assembly as claimed in claim 11, further comprising a receiving vessel attached to the second conduit and configured to receive the biological material therefrom.

15. An aseptic assembly as claimed in claim 11, wherein the first valve and the second valve are pressure openable valves having a normally closed configuration but movable to an open configuration when fluid pressure is applied thereto.

16. A storage vial comprising a vial body having a first end and a second end and defining an internal volume configured to contain a biological material therein, a first conduit connector positioned at the first end of the vial body, and a second conduit connector positioned at the second end of the vial body.

17. A storage vial as claimed in claim 16, further comprising an end cap removably attached to the first end of the vial body, wherein the first conduit connector is attached to the end cap.

18. A storage vial as claimed in claim 16, wherein an end portion of the second conduit connector is positioned within the internal volume of the vial body such that the second conduit connector and the vial body define a cell retention volume therebetween.

19. A storage vial as claimed in claim 16, further comprising a tube attached to the first conduit connector and extending into the internal volume of the vial body.

20. A storage vial as claimed in claim 16, wherein a longitudinal axis of at least one of the first conduit connector and the second conduit connector extends transverse to a longitudinal axis of the vial body.
